(19) United States
(12) Patent Application Publication
(10) Pub. No.: US 2021/0288350 A1
(43) Pub. Date: Sep. 16, 2021

(54) SOLID POLYMER ELECTROLYTE, METHOD FOR THE PRODUCTION THEREOF, AND ELECTROCHEMICAL STORAGE BATTERY/CELL COMPRISING SAME

(71) Applicants: INSTITUT POLYTECHNIQUE DE GRENOBLE, Grenoble (FR); UNIVERSITÉ D'AIX-MARSEILLE, Marseille Cedex 07 (FR); CENTRE NATIONAL DE LA RECHERCHE SCIENTIFIQUE, Paris (FR)

(72) Inventors: Renaud BOUCHET, La Tronche (FR); Ekaterina PAVLENKO, Grenoble (FR); Adrien LASSAGNE, Gieres (FR); Trang PHAN, Marseille (FR); Adele FERRAND, Aix En Provence (FR); Didier GIGMES, Allauch (FR); Sebastien MARIA, Les Pennes-Mirabeau (FR)

(21) Appl. No.: 17/254,664

(22) PCT Filed: Jun. 20, 2019
(86) PCT No.: PCT/EP2019/066376

§ 371 Date: Dec. 21, 2020

(30) Foreign Application Priority Data
Jun. 22, 2018 (FR) 1855580

(51) Int. Cl. H01M 10/0565; C08G 81/00; H01M 10/0525

(52) U.S. Cl. CPC H01M 10/0565; C08G 81/00; H01M 2300/0085; H01M 2300/0082; H01M 10/0525

(57) ABSTRACT

The invention relates to an improved solid polymer electrolyte SPE, in particular for storage batteries, and, even more particularly, for LMP storage batteries.

The objective of the invention is to provide a SPE that has, at low temperatures (≤40° C.), both high ionic conductivity and very good mechanical qualities in the solid state, which can limit or even eliminate the dendritic growth of metal in the storage battery, in this case lithium in LMP storage batteries.

To this end, the invention first and foremost relates to a Solid Polymer Electrolyte (SPE) comprising:
1.1—at least one linear three-block A-B-A or two-block A-B copolymer wherein:
   the A blocks are glassy or semi-crystalline polymers;
   the B block is a polymer
      that can be produced from a plurality of alkylene-glycol (AG) monomers selected from ethylene oxide (EO) and/or propylene oxide (PO);
      and/or selected from poly(ethylene-glycol) acrylates (PEGA), and/or poly(ethylene-glycol) methacrylates (PEGMA), and/or polyoxypropylene diamines;
optionally one or more silicone polymer, oligomer or monomer segment being distributed between the A & B blocks;
1.2—at least one electrolyte salt;
1.3—and at least one plasticiser.

The invention also relates to the method for producing such a SPE, and to the electrochemical devices (storage batteries) or the elements of these devices (electrodes) comprising this SPE.

### TECHNICAL FIELD

The field of the invention is that of electrochemical cells-storage batteries-batteries, in particular those of which the reaction is based on the element lithium.

More precisely, the invention relates to solid polymer electrolytes (SPE) that can be used in these electrochemical devices.

The invention also relates to the method for producing such a SPE.

The applications of these SPE in these electrochemical devices, in particular those of which the reaction is based on the element lithium, constitute other aspects of the invention.

### State of the Art—Technical Problem

“Storage battery” designates a unitary electrochemical device (cell) comprising two electrodes separated by an electrolyte. “Battery” designates an assembly of storage batteries connected together in order to obtain the desired capacity and voltage. In everyday language, the two terms are often confused.

A storage battery restores energy by converting the chemical energy into electrical energy, through reactions that occur at the electrodes. In the case where the storage battery is the seat of reversible redox reactions, this allows it to be rechargeable with respect to electrical energy with an external source. On the contrary, in an electric battery, the electricity-generating redox reactions are not reversible.

During the discharge of the storage battery, the negative electrode (anode) is the seat of an oxidation that generates an electron in the external circuit and an ion that migrates through the electrolyte. Simultaneously, a reduction takes place at the positive electrode (cathode) thanks to the supply of an electron by the external circuit and of an ion by the electrolyte: this ion can be stored in the material of the positive electrode, called host material. The electrons thus formed are recovered by the collectors and supply the external circuit with electrical current. During the charge, the ions take the reverse path, i.e. they are produced by oxidation at the positive electrode and migrate towards the negative electrode. The electrodes must therefore be both ion and electron conducting. The electrolyte has to be a good ion conductor, but electron insulator in order to force the electrons to pass through the external circuit. Otherwise, the performance of the storage battery deteriorates.

Lithium storage batteries offer the highest specific energy (energy/mass and the highest energy density (energy/volume). These lithium storage batteries have therefore imposed themselves for storing and delivering electrical energy in multiple applications, such as in particular high-energy applications: automobile, aeronautics, intermittent energy storage (solar and/or wind) . . . and applications relating to mobile electronic devices, of which in particular computer or mobile telephones.

There are three main types of lithium storage batteries:
lithium metal storage battery, where the negative electrode is comprised of metal lithium (material that raises safety issues);
lithium-ion storage batteries, where the lithium remains in the ionic state thanks to the use of an insertion compound, at the negative electrode (generally made of graphite) as well as at the positive electrode (cobalt dioxide, manganese, iron phosphate);
lithium-polymer storage batteries are a variant and an alternative to lithium-ion storage batteries. They deliver a little less energy, but are much safer.

In the framework of the present invention, interest is given more particularly to Lithium Metal Polymer (LMP) storage batteries. These storage batteries or batteries are more specially intended for automobile, aeronautical and intermittent energy applications (solar and/or wind).

Their energy density is lower than that of lithium-ion storage batteries, but LMP storage batteries, fully solid, do not carry the risk of explosion. Their self-discharging is relatively low. They have little or no pollution and no memory effect.

In LMP storage batteries, the elementary electrochemical cell comprises:
a current collector,
a cathode composed, for example, of vanadium oxide or of LiFePO₄, carbon and polymer electrolyte,
an electrolyte which is a mixture of lithium salt and a polymer material based on polyoxyethylene (PEO) used as a solvent,
an anode made from sheets of metal lithium.

This elementary cell, fully solid, also operates reversibly: the anode provides the supply of lithium ions during the discharging and the cathode act as a receptacle where the lithium ions are inserted. The two electrodes are separated by the solid polymer electrolyte, which conducts lithium ions. The conductivity of the ions is assured by the dissolution of lithium salts in the polymer material with a PEO base. This material is generally comprised of random copolymer(s) or blocks, or even PEO/reinforcing polymer composites.

The high viscosity at ambient temperature of this polymer material with a PEO base, provides a mechanical blocking that limits, even eliminates, dendritic growth, a deleterious phenomenon well known in lithium storage batteries. Dendritic growth takes place during the charging of the storage battery. The metal lithium is not deposited uniformly on the surface of the metal electrode, but in the form of dendrites that can short-circuit the electrochemical cell and thus cause the destruction thereof by overheating, even by explosion. In addition, these irregular dendritic deposits can also break into pieces which, not only is detrimental to the performance of the storage battery, but even more gravely, results in the presence of fragments of highly reactive lithium powder in the electrolyte.

The chemical inertia of this polymer material with a PEO base with regards to lithium substantially decreases the risks of explosive reactions, which, also, have tarnished the reputation of lithium storage batteries.

The texture of this polymer material with a PEO base also prevents electrolyte leaks, and its flexibility makes it possible to choose a configuration in sheets, adapted for industrial production and of which the geometrical criteria improve performance (large surface and low thickness of the electrolyte).

However, in order to obtain the required optimum conductivity, in particular in high-energy applications, the temperature of the polymer material with a PEO base, has to be kept between 80° C. and 90° C.

But at these high temperatures of optimum conductivity, the physical properties of the polymer material with a PEO base are degraded. This results in that the latter is no longer capable of mechanically opposing dendritic growth.

Furthermore, operation at these high temperatures of optimum conductivity, assumes that a portion of the energy of the storage battery (battery) is used for this purpose. This substantially decreases the useable energy density of the storage battery.

Moreover, this thermal constraint imposes latency time that delays the turning on of the storage battery, and therefore the supplying of electrical energy, at ambient temperature.

It therefore appears that the ionic conductivity and mechanical resistance properties of the polymer material with a PEO base, are antagonistic.

In this LMP technology based on electrolytes based on PEO, the ionic conductivities obtained at 40° C. are too low for optimum use and only the use of positive electrodes with little “grammage” (<0.5 mA/cm²) (low surface capacity) and low currents (<C/10; charge in 10 h (C=total capacity)) make it possible to recover the capacity at this temperature.

The scientific article A. Lassagne and al “Electrochimica Acta 238 (2017) 21-29: New approach to design solid block copolymer electrolytes for 40° C. lithium metal battery operation”, addresses this issue.

Thus this article discloses solid polymer electrolytes SPE constituted by three-block B-A-B copolymer, based on a central PEO A block and PolyStyrene (PS) PS-b-PEO-b-PS lateral B blocks:

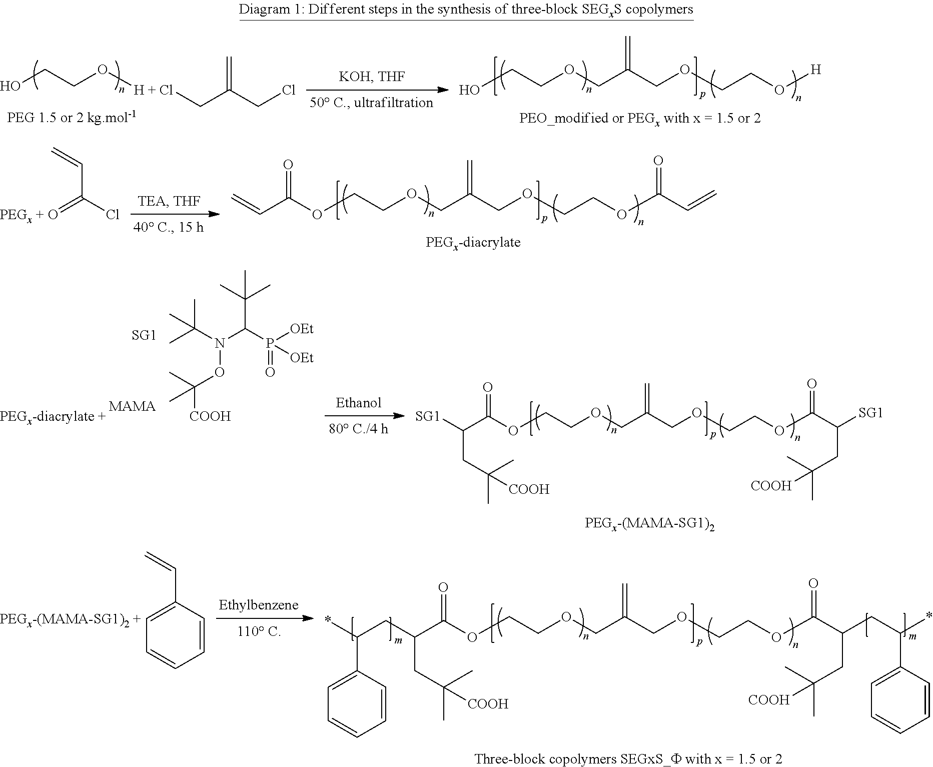

These poly(Styrene-EthyleneGlycolₓ-Styrene) copolymer blocks are noted as SEGₓS with x=1.5 or 2 which indicates the molar mass in kg·mol⁻¹ of the polyethylene glycol (PEG) used in the synthesis of the central block. The SEGₓS are obtained in several steps (Diagram 1): 1) the polycondensation of a polyethylene glycol PEG of molar mass of 1.5 or 2 kg·mol⁻¹ and of 3-chloro-2-propene in order to obtain the modified PEO central block, 2) the modification of the ends of the PEO modified by esterification then by intermolecular radical addition with the alkoxyamine MAMA-SG1 in order to obtain the macroinitiator PEO-(MAMA-SG1)₂, 3) the radical polymerisation controlled by the nitroxides of the styrene by using the macroinitiator PEO-(MAMA-SG1)₂. These SEGₓS are then solubilised with a 2 bis-trifluoromethanesulfonylimide lithium salt (LiTFSI) in a dichloromethane/acetonitrile mixture, to form the SEGₓS_ϕ_{c}. ϕ_{c} corresponds to the volume percentage of conductive phase (modified PEO loaded with LiTFSI at an EO/Li ratio=25). This solution of SEGₓS_ϕ_{c} is subjected to an elimination of the solvent in order to produce SEGₓS_ϕ_{c} films 100 μm thick.

The SPE described in this prior document can be improved in terms of the ionic conductivity/mechanical properties compromise.

Document FR 2899235 describes a SPE that comprises a three-block copolymer, and in particular a polystyrene-poly(oxyethylene)-polystyrene copolymer, intended for being implemented in lithium storage batteries. The SPE described in this document can however be improved.

### Objectives of the Invention

In these circumstances, the present invention aims to satisfy at least one of the objectives mentioned hereinafter.
One of the substantial objectives of the present invention is to provide an improved solid polymer electrolyte SPE, in particular for storage batteries, and, even more particularly, for LMP storage batteries.
One of the substantial objectives of the present invention is to provide an improved solid polymer electrolyte SPE, in particular for storage batteries, and, even more particularly, for lithium LMP storage batteries, this SPE having at low temperatures, i.e. for example close to the ambient temperature and/or less than or equal to—in ° C., and in an increasing order more preferably—: 85; 80; 70; 60; 50; 40; both high ionic conductivity and very good mechanical qualities in the solid state, which can limit or even eliminate the dendritic growth of metal in the storage battery, in this case lithium in LMP storage batteries.
One of the substantial objectives of the present invention is to provide an improved solid polymer electrolyte SPE, in particular for storage batteries, and, even more particularly, for LMP storage batteries, this SPE having at low temperatures, i.e. for example close to the ambient temperature and/or less than or equal to—in ° C. and in an increasing order more preferably—: 85; 80; 70; 60; 50; 40; of a low reactivity with the metal on which the electrochemistry of the storage battery is based, for example lithium in LMP storage batteries.
One of the substantial objectives of the present invention is to provide an improved solid polymer electrolyte SPE, in particular for storage batteries, and, even more particularly, for LMP storage batteries, this SPE having at low temperatures, i.e. for example close to the ambient temperature and/or less than or equal to—in ° C. and in an increasing order more preferably—: 85; 80; 70; 60; 50; 40; of reduced volatility and without solvent vaporisation.
One of the substantial objectives of the present invention is to provide an improved solid polymer electrolyte SPE, in particular for storage batteries, and, even more particularly, for LMP storage batteries, this SPE being light, flexible, easy to handle and easy to implement.
One of the substantial objectives of the present invention is to provide a simple and economical method, for the producing of a SPE such as mentioned in the objectives hereinabove.
One of the substantial objectives of the present invention is to provide an electrochemical storage battery (or a cell) comprising at least one SPE such as mentioned in the objectives hereinabove, this storage battery, in particular of the LMP type, having very good cycling resistance, good discharging capacity and a high faradaic efficiency/coulombic effectiveness, at low temperatures, i.e. for example close to the ambient temperature and/or less than or equal to—in ° C. and in an increasing order more preferably—: 85; 80; 70; 60; 50; 40.
One of the substantial objectives of the present invention is to provide an electrochemical storage battery (or a cell) comprising at least one SPE such as mentioned in the objectives hereinabove, this storage battery, in particular of the LMP type, having very good recycling resistance, a discharging capacity and a faradaic efficiency/coulombic effectiveness, at 40° C., greater than those of an LMP storage battery (or of a cell), at 80° C.

### BRIEF DESCRIPTION OF THE INVENTION

These objectives, among others are achieved by the present invention which first and foremost relates to a Solid Polymer Electrolyte (SPE) comprising:
1.1—at least one linear three-block A-B-A or two-block A-B copolymer wherein:
   the A blocks are glassy or semi-crystalline polymers;
   the B block is a polymer
      that can be produced from one or more alkylene-glycol (AG) monomers selected from ethylene oxide (EO) and/or propylene oxide (PO);
      and/or selected from poly(ethylene-glycol) acrylates (PEGA), and/or poly(ethylene-glycol) methacrylates (PEGMA), and/or polyoxypropylene diamines;
optionally at least one silicone polymer, oligomer or monomer segment being distributed between the A and B blocks;
1.2—at least one electrolyte salt;
1.3—and at least one plasticiser

More particularly, the SPE can include:
1.1—at least one linear three-block A-B-A or two-block A-B copolymer wherein:
   the A block or blocks are glassy or semi-crystalline polymers;
   the B block is a polymer
      that can be produced from one or more alkylene-glycol (AG) monomers selected from ethylene oxide (EO) and/or propylene oxide (PO);
      and/or selected from poly(ethylene-glycol) acrylates (PEGA), and/or poly(ethylene-glycol) methacrylates (PEGMA), and/or polyoxypropylene diamines;
optionally at least one silicone polymer, oligomer or monomer segment being distributed between the A and B blocks;
1.2—at least one electrolyte salt;
1.3—and at least one plasticiser, selected from polar solvents, of molar mass less than or equal to 1,000 g/mol or even better to 500 g/mol, the concentration in plasticiser being comprised between 15% excluded and 40% included in dry weight with respect to the total mass of the SPE.

This new plasticised SPE material is singularly effective and advantageous in that it offers very good ionic conductivity and very good resistance or very good mechanical reinforcement, favourable to the blocking of the process of the formation of metal dendrites, for example lithium when it entails applications in LMP storage batteries.

The performance, for example at 40° C., of storage batteries that comprise this SPE are greater than or equal to those of storage batteries available on the market and of which the operating temperature is 80° C. This represents gain of more than 40° C., with higher or equal electrical performance. These results are particularly remarkable for “all-solid-state” storage batteries/batteries.

In addition to this performance, “all-solid-state” storage batteries (e.g. LMP) that implement the SPE according to invention, have a fundamental advantage in terms of safety, with respect to storage batteries/batteries that use liquid electrolytes at high saturation vapour pressure and highly flammable.

In addition to its improves conductivity at low temperature, its good mechanical resistance and the reinforcing of safety that it contributes to, this SPE material according to invention also benefits from great ease in implementation.

In a preferred embodiment of the invention, the SPE is at least partially crosslinked.

In another of its aspects, the invention relates to a method for producing a SPE such as described in the present disclosure. This method consists substantially of:
(i) Implementing or synthesizing the three-block A-B-A copolymer 1.1, preferably:
   (i).1—by polycondensation, on the one hand, of B sub-blocks of molar mass advantageously comprised between 0.5 and 5 kg·mol⁻¹, and, even better, between 1 and 3 kg·mol⁻¹, and, on the other hand, of at least one precursor of unsaturated segments, preferably alkenylated, this precursor being preferably a halogeno-alkene;
   (i).2—then by radical polymerisation with the recurring units of the A blocks;
(ii) Doping the products obtained in step (i) by mixing them with at least one electrolyte salt 1.2 in solution;
(iii) Possibly adding at least one initiator, preferably at least one photoinitiator and/or at least one thermal initiator;
(iv) Optionally forming the mixture obtained in step (ii);
(v) Optionally eliminating at least partially the solvent or solvents present in the mixture, in particular the one implemented for the electrolyte salt solution 1.2 of step (ii);
(vi) Optionally crosslinking, by actinic activation, in particular under UV, and/or by thermal activation at a temperature greater than or equal to (in ° C. and in increasing order of preference): 60; 70; 80; 90; 100; ideally comprised between 80 and 120° C.;
(vii) Incorporating the plasticiser 1.3.

In another of its aspects, the invention relates to an electrochemical storage battery comprising at least one SPE such as described in the present disclosure.

In another of its aspects, the invention aims for an electrode for electrochemical device comprising at least one SPE such as described in the present disclosure.

### Definitions

Throughout the entire present disclosure, any singular designates indifferently a singular or a plural.

The definitions given hereinafter by way of examples, can be used for the interpretation of the present disclosure:
“storage battery”: unitary electrochemical device (cell) comprising two electrodes separated by an electrolyte.
“battery”: assembly of storage batteries connected together in order to obtain the desired capacity and voltage.
“Solid Polymer Electrolyte SPE”: polymer material solid at ambient temperature (e.g. 10-40° C.), to be distinguished by its self-supported physical aspect that does not creep and without exuding of fluid, of a gelled or liquid polymer material at ambient temperature.
“polymer”: homopolymer or copolymer.
“about” or “substantially” means plus or minus to the nearest 10%, even plus or minus to the nearest 5%, in relation to the measurement unit used.
“comprised between Z1 and Z2” means that one and/or the other of the limits Z1, Z2 is included or not in the interval [Z1, Z2].

### DETAILED DESCRIPTION OF THE INVENTION

### SPE

### 1.1—Three-Block A-B-A or Two-Block A-B Linear Copolymer

The SPE according to invention is preferably at least partially crosslinked. In this configuration, the three-block A-B-A copolymer 1.1 can be the component involved in this crosslinking.

For this purpose, the A block polymers and/or the B block polymer, can be a carrier or carriers of at least two crosslinking groups CG per molecule, preferably a pendant group, said groups CG being able to react together to form crosslinking bridges, preferably by a thermally-activated crosslinking and/or actinically-activated crosslinking, in particular under UV.

According to a remarkable characteristic of the invention, the crosslinking groups CG can be selected from the group comprising—ideally constituted by—monovalent radicals including at least one unsaturation, advantageously ethylenic and/or alkynilic.

On an interesting alternative of the invention, the crosslinking groups CG are carried by all or a portion of the recurring units of the B block.

In a particular embodiment, each recurring unit of the B block is a carrier of a pendant group CG.

The actinic activation, in particular under UV, of the reaction between the groups CG for the crosslinking is favoured. However, it is possible to consider, as a substitution or as a supplement, other activation modes, for example thermal activation.

The copolymers with PEO blocks used in the solid polymer electrolytes (SPE) can be two-block A-B copolymers or three-block A-B-A copolymers.

The two-block A-B linear polymer can advantageously have the following general formula (I):

(a)ₙ₁−(b)ₘ (I)
with
(a) recurring unit (monomer) of the A block polymer;
(b) recurring unit (monomer) of the B blocks polymer;
n1 corresponding to a number comprised between 20 and 576, preferably between 20 and 400, and, even more preferably, entre 30 and 80;
m corresponding to a number comprised between 350 and 684, preferably between 400 and 550, and, even more preferably, entre 425 and 460.

The three-block A-B-A linear copolymer can advantageously have the following general formula (I-bis):

(a)_{n′}−(b)_{m′}−(a)_{n′} (I-bis)
with
(a) recurring unit (monomer) of the A block polymer;
(b) recurring unit (monomer) of the B blocks polymer;
n′ corresponding to a number comprised between 10 and 288, preferably between 10 and 200, and, even more preferably, entre 15 and 40;
m′ corresponding to a number comprised between 350 and 684, preferably between 400 and 550, and, even more preferably, entre 425 and 460.

The A blocks are advantageously:
glassy or semi-crystalline homopolymers that can be produced from a monomer selected from styrene, o-methylstyrene, p-methylstyrene, m-t-butoxystyrene, 2,4-dimethylstyrene, m-chlorostyrene, p-chlorostyrene, 4-carboxystyrene, vinylanisole, vinylbenzoic acid, vinylaniline, vinylnaphthalene, 9-vinylanthracene, alkyl methacrylates from 1 to 10C, acrylic acid, methacrylic acid, acrylonitrile, isoprene, butadiene, acrylamides;
or random copolymers able to be produced from a monomer described hereinabove and one or more other monomers selected from 4-chloromethyl styrene, poly(ethylene glycol) (meth)acrylates, alkyl acrylates from 1 to 10 C, acrylic acid, methacrylic acid.

The A block is more preferably chosen for its solvation properties of the electrolyte salt. Its chemical nature can therefore depend on the electrolyte salt selected, described in more detail hereinafter.

More preferably, the A blocks are polymers that can be produced from one or more monomers, selected from:
styrene and the mono- or poly-substituted derivatives thereof, the latter being preferably selected from the group comprising—ideally constituted by—: o-methylstyrene, p-methylstyrene, m-t-butoxystyrene, 2,4-dimethylstyrene, m-chlorostyrene, p-chlorostyrene, 4-carboxystyrene, 4-chloromethylstyrene and the combinations thereof;
anisole and the mono- or poly-substituted derivatives thereof, the latter being preferably selected from the group comprising—ideally constituted by—: 4-vinylanisole, 3-vinylanisole, 2-vinylanisole;
aniline and the mono- or poly-substituted derivatives thereof, the latter being preferably selected from the group comprising—ideally constituted by—: 4-vinylaniline, 3-vinylaniline;
benzoic acid and the mono- or poly-substituted derivatives thereof, the latter being preferably selected from the group comprising—ideally constituted by—: 4-vinylbenzoic acid, 3-vinylbenzoic acid, 2-vinylbenzoic acid, 4-(2-propenyl)benzoic acid;
naphthalene and the mono- or poly-substituted derivatives thereof, the latter being preferably selected from the group comprising—ideally constituted by—: 2-vinylnaphthalene, 1-vinylnaphthalene;
anthracene and the mono- or poly-substituted derivatives thereof, the latter being preferably selected from the group comprising—ideally constituted by—: 9-vinylanthracene;
pyridine and the mono- or poly-substituted derivatives thereof, the latter being preferably selected from the group comprising—ideally constituted by—: 4-vinylpyridine, 2-vinylpyridine;
an acrylamide and the mono- or poly-substituted derivatives thereof, the latter being preferably selected from the group comprising—ideally constituted by—: acrylamide, N,N-dimethyl acrylamide, N,N-diisopropyl acrylamide, N-hydroxyethyl acrylamide;
acrylic acid, methacrylic acid, the salts thereof and the mono- or poly-substituted derivatives thereof, the latter being preferably selected from the group comprising—ideally constituted by—: alkyl acrylates from 1 to 10C, alkyl methacrylates from 1 to 10C, acrylic acid, poly(ethylene glycol) (meth)acrylates.

In a preferred embodiment, the A block or blocks are polystyrenes. According to this embodiment, the molar mass of the A block is more preferably comprised between 2,000 and 60,000 g/mol, preferably between 2,000 and 41,600 g/mol, and even more preferably, entre 3,100 and 8,300 g/mol.

Through the definition of copolymer, the monomers that can produce the A blocks are different from the monomers that can produce the B blocks.

The B block is a polymer that can be produced from one or more alkylene-glycol (AG) monomers selected from ethylene oxide (EO), propylene oxide (PO), poly(ethylene-glycol) acrylates, (PEGA), poly(ethylene-glycol) methacrylates (PEGMA), and/or polyoxypropylene diamines, of which in particular those marketed under the brand Jeffamines® diamines.

Preferably, the B blocks are selected from blocks of poly(ethylene oxide) (PEO), blocks of poly(propylene oxide) (PPO) and blocks of PEO/PPO random copolymers.

Preferably, the B block comprises B sub-blocks or molar mass comprised between 0.5 and 5 kg·mol⁻¹, and, even better, between 1 and 3 kg·mol⁻¹.

In a preferred embodiment, the B block is a PEO.

According to an example, the molar mass of the B block is 20,000 g/mol.

According to the characteristics described hereinabove of A and B blocks, the proportion of the A block or blocks of the copolymer can be comprised between 10% and 75% by mass, preferably between 10% and 68% by mass, and even more preferably, between 14% and 30% by mass, with respect to the total mass of the copolymer.

According to an embodiment, the two-block A-B copolymers include a first block formed by a poly(alkyl methacrylate) such as poly(lauryl methacrylate) (PLMA), poly(n-butyl methacrylate) (PnMBA), or poly(methyl methacrylate), and a second block formed by poly(polyethylene glycol methacrylate, 9 units of EO) (PMAPEG). These copolymers can be synthesised radically.

According to another embodiment, one or more silicone polymer, oligomer or monomer segments can be distributed between the A & B blocks. This or these silicone segments can have a glass transition temperature that is strictly less than that of A and B blocks free from silicone segment. The incorporation of one or more segments silicones makes it possible to increase the molecular dynamics of the copolymer. Thus, the ionic conduction of the SPE according to the invention can be improved.

These segments include one or more silicone units of the following formulas (II) and/or (III):

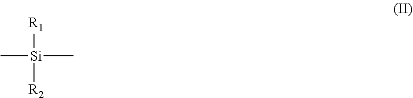

wherein substituents R1 R2 are selected independently from the group comprised of:
—CH₂
—(CH₂)₃O—(CH₂CH₂O)ₒ—CH₃
—(CH₂)₂Si(CH₃)₂OSi(CH₃)₂—(CH2)₃O(CH₂CH₂O)ₒ—CH₃
—(CH₂)₂Si(CH₃)₂(CH2)₃O—(CH2CH2O)ₒ—CH₃ and
—(CH₂)₂Si(CH₃)₂O—(CH₂CH₂O)ₒ—CH₃
   with n corresponding to an integer preferably comprised between 1 and 20.

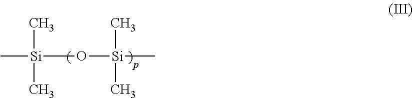

with p an integer preferably comprised between 1 and 10.

### 1.2—The Electrolyte Salt

Advantageously, the electrolyte salt 1.2 is selected from the alkali metal salts, more preferably from the following compounds: LiSCN, LiN(CN)₂, LiClO₄, LiBF₄, LiAsF₆, LiPF₆, LiCF₃SO₃, Li(CF₃SO₂)₂N, Li(CF₃SO₂)₃C, LiN(SO₂C₂Fs)₂, LiN(SO₂CF₃)₂, LiN(SO₂CF₂CF₃)₂, lithium alkylfluorophosphates, lithium oxalatoborate, lithium bis(chelato)borates having at least one 5 to 7-membered ring, lithium bis(trifluoromethanesulfoneimide) (LiTFSI), LiPF₃(C₂F₅)₃, LiPF₃(CF₃)₃, LiB(C₂O₄)₂, LiPF₆, LiSbF₆, LiClO₄, LiSCN, LiAsF₆, NaCF₃SO₃, NaPF₆, Na ClO₄, NaI, NaBF₄, NaAsF₆, KCF₃SO₃, KPF₆, Kl, LiCF₃CO₃, NaClO₃, KBF₄, KPF₅, Mg(ClO₄)₂, and Mg(BF₄)₂ AgSO₃CF₃, NaSCN, KTFSI, NaTFSI, Ba(TFSI)₂, Pb(TFSI)₂, Ca(TFSI)₂ and the mixtures thereof.

The lithium salts are particularly preferred.

According to a possibility, the electrolyte salt 1.2 according to invention can contain a mineral filler constituted, for example, of particles of ceramic, for example Al₂O₃, TiO₂, and/or SiO₂. The size of these particles is advantageously less than or equal to 5 nm.

According to a privileged modality of the invention, allowing for the optimisation of the conductivity of the SPE, the latter has a ratio [M_{B}/M_{1.2}] of the number of moles M_{B} of the constituent monomer or monomers of the B block, over the number of moles M_{1.2} of the electrolyte salt 1.2, such that—in an increasing order more preferably—:

5≤[M_{B}/M_{1.2}]≤50; 8≤[M_{B}/M_{1.2}]≤40; 10≤[M_{B}/M_{1.2]}≤35; 12≤[M_{B}/M_{1.2}]≤30.

In the case where the B block constituted of monomer ethylene oxide EO and/or the electrolyte salt 1.2 is a lithium salt: 14≤[M_{B}/M_{1.2}]≤28.

### 1.3—The Plasticiser

The SPE according to the invention is plasticised by means of the plasticiser 1.3. Contrary to the solvents in the production of a SPE, which are generally eliminated during the production of the SPE, for example by evaporation, the plasticiser is here intended for remaining in the SPE. In the framework of the present invention, the production solvents, designated as “solvent”, and the plasticiser are distinguished. The plasticiser has particularly for role to lower the glass transition temperature of the B block in the SPE. Thus, good ionic conductivity of the SPE at low temperature can be obtained. The plasticiser is in particular chosen for its electrochemical stability in the conditions of use of the SPE according to the invention.

The plasticiser 1.3 is, preferably, selected from polar solvents, more preferably from those of molar mass less than or equal to 1,000 g/mol or even better to 500 g/mol, and, more preferably from the group comprising—ideally composed of—
ethers, in particular alkylene-glycols, and, more specifically tetraethylene glycol dimethyl (TEGDME), triethylene glycol dimethyl ether (TrEGDME), diethylene glycol dimethyl ether (DEGDME), triethylene glycol dibutylether (TEGDBE), Dipropylene glycol dimethyl ether (DPGDME);
carbonates, in particular linear carbonates such as dimethylcarbonate (DMC), ethyl methyl carbonate (EMC), diethylcarbonate (DEC) and cyclic carbonates such as ethylene carbonate (EC), vinylenecarbonate (VC), propylene carbonate (PC), and fluoro ethylene carbonate (FEC);
nitriles and in particular succinonitrile;
lactones and in particular γ-butyrolactone;
and the mixtures thereof;

Alternatively, the plasticiser 1.3 can be selected from the group comprising—ideally composed of—
ethers, in particular alkylene-glycols, and, more specifically tetraethylene glycol dimethyl (TEGDME), triethylene glycol dimethyl ether (TrEGDME), diethylene glycol dimethyl ether (DEGDME), triethylene glycol dibutylether (TEGDBE), Dipropylene glycol dimethyl ether (DPGDME);
carbonates, in particular linear carbonates such as dimethylcarbonate (DMC), ethyl methyl carbonate (EMC), diethylcarbonate (DEC) and cyclic carbonates such as ethylene carbonate (EC), vinylenecarbonate (VC), and propylene carbonate (PC);
nitriles and in particular succinonitrile;
lactones and in particular γ-butyrolactone;
and the mixtures thereof.

In accordance with a distinctive and interesting characteristic of the invention, the concentration in plasticiser 1.3 is less than or equal to—in % by dry weight with respect to the total mass of the SPE [comprising at least 1.1, 1.2 and 1.3] and according to an increasing order more preferably −45; 40; 35; 30; 25 this concentration being even more preferably comprised between 10% and 40% by dry weight, even between 10 and 32% by dry weight, even between 15% excluded and 40% included in dry weight, preferably between 15 and 30% by dry weight.

It must be observed that this limited quantity of plasticiser 1.3 goes along with a high electrical conductivity, at least greater than or equal to the electrical conductivity of the SPE of the prior art. Furthermore, this limited quantity of plasticiser 1.3 makes it possible to obtain a SPE with good mechanical resistance at ambient temperature, with respect to the SPE comprising a proportion in plasticiser greater than 50%, even greater than 70%, by mass with respect to the total mass of the SPE.

### 1.4—Other Ingredients

The SPE according to the invention also includes, at least in trace amounts, markers of its method of production, and in particular of the two-block or three-block polymer.

Thus the SPE according to the invention comprises, in a particular embodiment of the invention linked to the production of the SPE:
at least one thermal initiator, preferable selected from the group comprising—ideally composed of the following products—peroxides, hydroperoxides, nitriles and the mixtures thereof, and, even more preferably, from the group comprising—ideally composed of the following products—benzoyl peroxide, cumyl peroxide and the mixtures thereof;
and/or at least one photochemical initiator, preferably selected from phenyl ketones and the mixtures thereof, 2-Hydroxy-4′-(2-hydroxyethoxy)-2-methylpropiophenone being particularly preferred.

### 1.5—Physical-Chemical Characteristics of the SPE

The material according to invention is singularised by a nano-structuring with polymer domains formed by B blocks (e.g. modified PEO), seat of the ionic conductivity and of the polymer domains formed by A blocks (PS), procuring a mechanical reinforcement. This nano structuring is a key element, among others, for the blocking of the formation of metal dendrites in particular of lithium.

Thus, advantageously, the SPE according to invention is characterised by a nano-separation, entre at least one phase comprising the A blocks and at least one phase comprising the B block more preferably by an SAXS diffraction peak using a copper cathode (λ=1.54 Å) at 20° C., with q1 comprised between 0.05 and 0.4 nm⁻¹, preferably between 0.1 and 0.5 nm⁻¹, even between 0.1 and 0.35 nm⁻¹ and, more preferably between 0.15 and 0.3 nm⁻¹, even more preferably between 0.15 and 0.25 nm⁻¹. The SPE characterised by this nano-separation can thus include a phase comprising the A blocks and at least one phase comprising the B block (e.g. modified PEO), of a period substantially comprised between 20.5 nm and 41 nm, the period corresponding here to the total average size of the unit formed by an A block and a B block.

The nano-separation obtained is more preferably according to a cylindrical or gyroid morphology that makes it possible to minimise the tortuosity of the conducting domains and thus achieve a higher conductivity. This morphology can in particular depend on the volume fraction of the A and B blocks. To obtain the morphology described, the volume fraction of the A block can be comprised between 15% and 40%, preferably between 15% and 35%, even more preferably between 20% and 30%, in relation to the total volume of the copolymer.

In accordance with the invention, the chemical modification of the PEO, by adding unsaturations, allows for the crosslinking of the material which, on the one hand, freezes the nano-structuring, and, on the other hand, allows for the absorption of the plasticiser 1.3, and this with good mechanical resistance of the SPE material.

Another quality of the SPE material according to the invention is that the B block and the plasticiser 1.3 form a homogeneous mixture. B and 1.3 are not subject to any phase separation, dephasing or exudation whatsoever, in usual conditions of use.

Moreover, one of the major interests of the SPE material according to the invention is to have an excellent ionic conductivity/mechanical resistance compromise, at temperatures less than 80° C., for example of about 40° C., even at ambient temperatures less than 40° C.

This this material is characterised by an ionic conductivity at 40° C. greater than or equal to 1.10⁻⁴, preferably to 3.10⁻⁴, and, even more preferably to 4.10⁻⁴, even 4.6±0.5*10⁻⁴; and by a Young's modulus (in MPa, at 40° C., and for a mass % of B block between 10 and 40% in the three-block A-B-A 1.1) greater than or equal to 0.05, preferably to 0.1, and, even more preferably to 0.30.

### Method for Producing the SPE

### Step (i)

The producing of the SPE according to invention entails a synthesis of two-block A-B or three-block A-B-A copolymers, with modification of the copolymers by introduction of crosslinking functional groups.

This step (i) comprises more preferably the following sub-steps:
(i).1—by polycondensation, on the one hand, of B sub-blocks of molar mass advantageously comprised between 0.5 and 5 kg·mol⁻¹, and, even better, between 1 and 3 kg·mol⁻¹, and, on the other hand, of at least one precursor of unsaturated segments, preferably alkenylated, this precursor being preferably a halogeno-alkene;
(i).2—then by radical polymerisation with the recurring units of the A blocks.

The bloc B can be modified by the introduction of an unsaturated function, for example isobutenes, by polycondensation, homogeneously distributed, all along the PEO chain.

In a particular embodiment, it is possible to synthesise a three-block A-B-A, with A: poly(4-methylstyrene) and B: poly(oxypropylene-oxyethylene), the B block able to be designated equivalently Jeffamine® ED-2003. The chemical structure of the copolymer before crosslinking on the double bonds is the following—formula (IV)—:

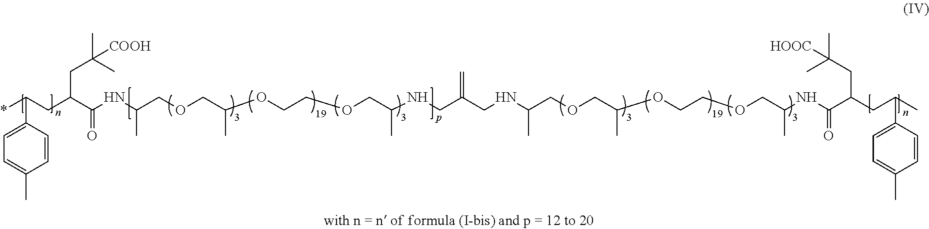

In another particular embodiment, it is possible to synthesise a three-block A-B-A, with A: poly(4-methylstyrene) and B: PEO. The chemical structure of the copolymer before crosslinking on the double bonds is the following—formula (V)—:

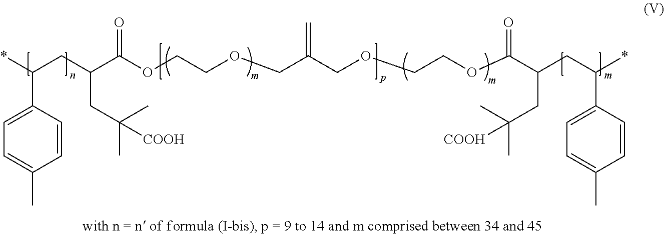

In another particular embodiment, it is possible to synthesise a three-block A-B-A, with A: polystyrene and B: poly(oxypropylene). The chemical structure of the copolymer before crosslinking on the double bonds is the following—formula (VI)—:

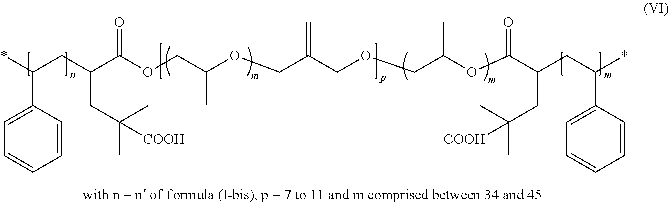

In the preferred embodiment, a three-block A-B-A is synthesised, with A: polystyrene and B: PEO.

The PEO is modified by the introduction of an unsaturated function, for example isobutenes, by polycondensation, homogeneously distributed, all along the PEO chain.

The PEGx blocks are obtained by polycondensation between the oligomers of PEO, polyethylene glycol (PEG) and 3-chloro-2-(chloromethyl)-1-propene. They are noted as PEGx with x the molar mass, in kg·mol⁻¹, of the condensed PEG. This synthesis was carried out with PEG of 1.5 kg·mol-1 (PEG1.5) and of 2 kg·mol-1 (PEG2) leading to polymers having double bonds (isobutene) that can be crosslinked distributed in a controlled manner all along the chain (every 34 or 45 EO units respectively). The copolymers are obtained by radical polymerisation controlled by nitroxides (cf. formula hereinbelow). Different PS/PEGx/PS compositions can be produced.

The chemical structure of the copolymer before crosslinking on the double bonds is as follows—formula (VII)—:

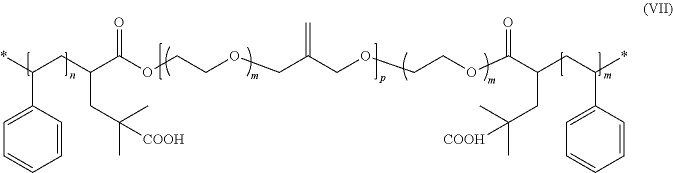

with n=n′ of formula (I-bis), more preferably comprised between 13 and 55, more preferably between 30 and 45, p=9 to 14 and m comprised between 34 and 45
   Steps (ii) & (iii)

The modified AB or ABA copolymers are then doped with at least one electrolyte salt 1.2.

According to a remarkable characteristic of the invention, the electrolyte salt 1.2 is at least partially dissolved in at least one solvent, designated equivalently production solvent, preferably selected from polar solvents, and, even more preferably from the group, comprising—ideally constituted by—the following compounds: substituted ethers, substituted amines, substituted amides, substituted alkyls, substituted PEG, alkyl carbonates, nitriles, boranes and lactones, and the mixtures thereof; tetrahydrofurane, methyl-ethyl-ketone, acetonitrile, ethanol, dimethylformamide, dichloromethane, acetonitrile taken individually or in mixtures thereof, being particularly preferred.

In the preferred embodiment, the PS-PEGx-PS materials obtained are doped [step (ii)] with at least one electrolyte salt 1.2, for example a LiTFSI salt and to which are added [step (iii)] at least one photoinitiator (for example hydroxy-4′-(2-hydroxyethoxy)-2-methylpropiophenone) and/or at least one thermal initiator (for example benzoyl peroxide).

This addition of initiator is carried out at 0.1 to 6% by weight, for example 2% by weight, with respect to the total PS-PEGₓ-PS/salt 1.2/initiator mixture. This addition is advantageously carried out by dissolution in a solvent, designated equivalently production solvent, e.g. in a dichloromethane/acetonitrile solution.

In a preferred embodiment of the method, the mixture of step (iii) [namely PS-PEGx-PS/salt 1.2/initiator/solvent] comprises from 10 to 45% by weight of solvent, for 90 to 55% by weight of A-B-A or A-B block copolymer, more preferably from 15 to 30% by weight of solvent, for 85 to 70% by weight of A-B-A or A-B block copolymer.

### Step (iv)

Preferably, the modified A-B or A-B-A are formed, for example transformed into mass objects or into films, membranes, or sheets of a thickness comprised for example between 10 and 200 microns.

Advantageously, this forming consists of a pouring of the solution on a suitable support/containing.

According to variants that make it possible to manufacture a SPE in the form of sheets, films or membranes, it is possible to use known techniques such as spin coating, roll coating, curtain coating, by extrusion etc.

Step (v)

This forming is accompanied by a passing from the liquid state to the solid state, more preferably by elimination of solvent(s), designated equivalently production solvent(s).

In practice, for example an evaporation of the solvent is carried out, designate equivalently production solvent, so as to form a mass object or a film.

The quantity of electrolyte salt 1.2 in the solution is adjusted to produce at the end of the optional step (iv), a solid form of SPE of which the [M_{B}/M_{1.2}] ratio is such as defined hereinabove.

Step (vi)

The crosslinking consolidates the forming and the nano-structuring of the material.

For example, the objects obtained at the end of step (iv), such as the films, are the crosslinked between 80 and 120° C., for example at 100° C. and/or by actinic activation, in particular under UV; for example under a UV P300 MT “Power supply” lamp marketed by the company Fusion UV system Inc” using a UV generator of 15 mW/cm² (0.25 mJ/cm²), for a λ=200-400 nm.

Step (vii)

The key component 1.3 of plasticising/gelification is finally incorporated.

For example, the crosslinked objects, in particular the films, in step (v) are plasticised with the plasticiser 1.3, for example Tetraethylene-glycol-dimethyl-ether (TEGDME).

### Applications: Electrodes—Electrochemical Cells—Storage Batteries—Batteries

The making available of a new effective SPE gives access to new electrochemical devices constituted at least partially by this SPE.

In particular, the invention relates to:
An electrode for electrochemical device comprising at least one SPE according to the invention or obtained by the method according to the invention.
An electrochemical cell and a storage battery comprising an electrolyte and electrodes at least one of which includes, preferably, metal lithium and at least one other of which contains, preferably, at least one lithium insertion compound, wherein at least one SPE according to the invention or obtained by the method according to the invention, is present in the electrolyte and/or in at least one of the electrodes.

### EXAMPLES

The examples that follow illustrate a preferred embodiment of the production of SPE according to invention, through its composition, its method of production and its physical and chemical characteristics.

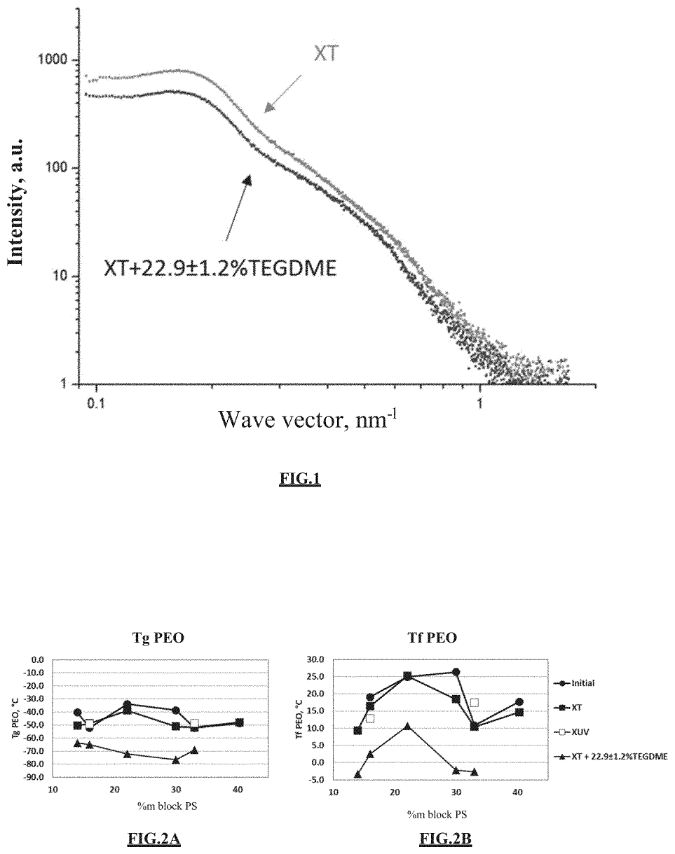

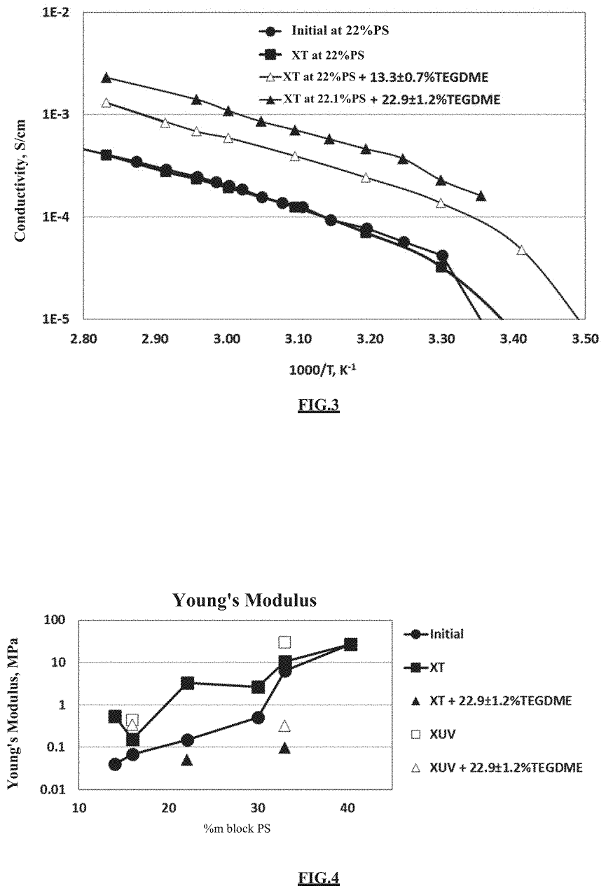

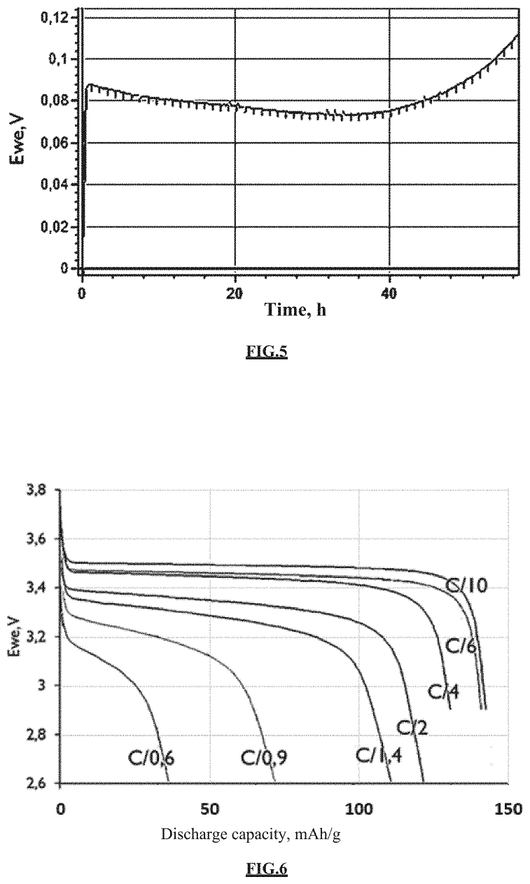

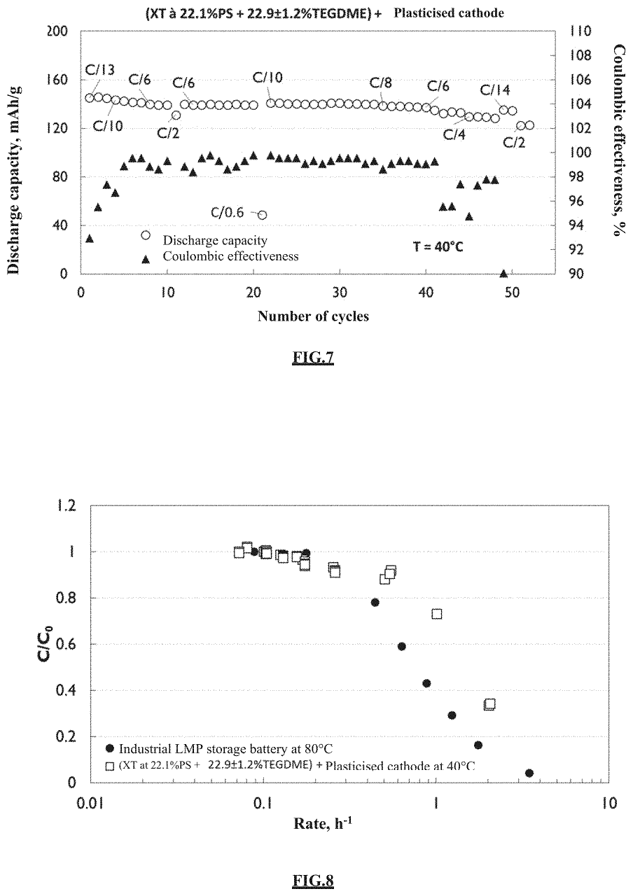

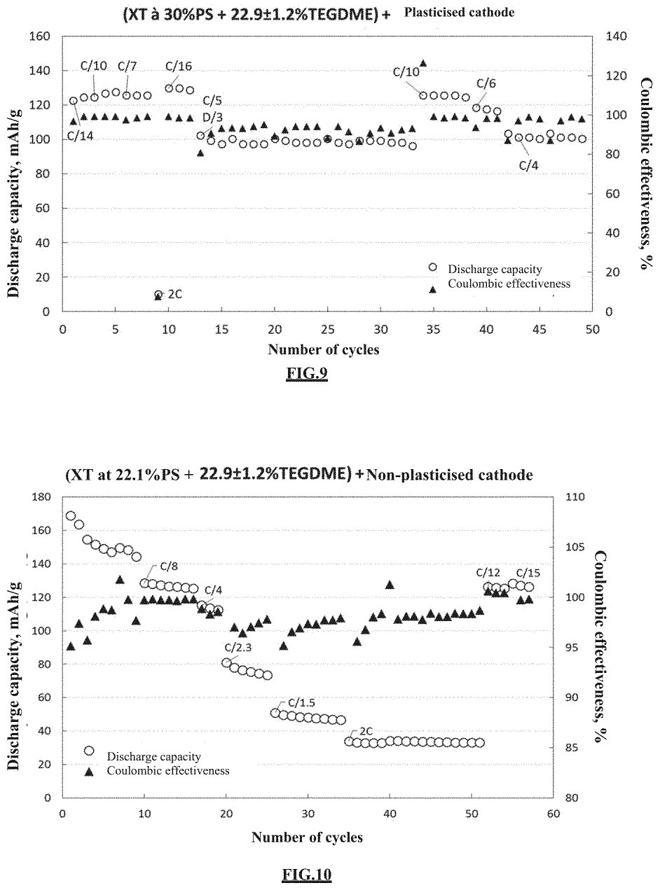

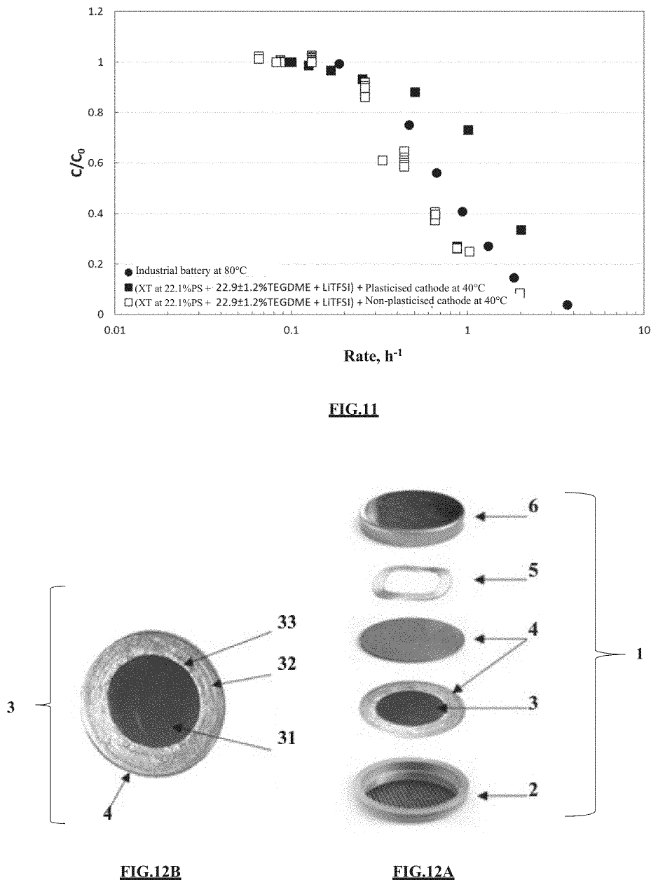

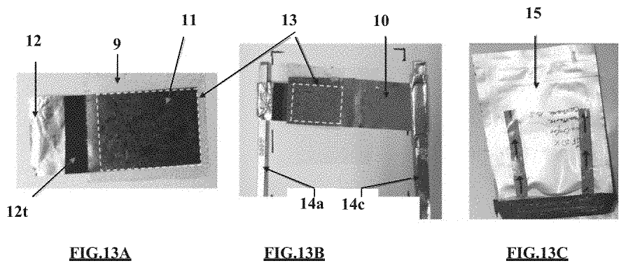

These examples are described in reference to the accompanying figures wherein:
FIG. 1 shows a curve of the signals of the intensity of the diffusion of the X-rays at the small angles (arbitrary unit) according to the wave vector in nm⁻¹ (SAXS by using a copper cathode (λ=1.54 Å) at 20° C.) for the SPE of example 1.
FIG. 2A shows the curves of the change in the glass transition temperature Tg with the mass % of PS in the block copolymer electrolytes, produced according to example 1: not crosslinked, crosslinked (thermal and photochemical activation) and crosslinked/plasticised.
FIG. 2B shows curves of the changes in the glass transition temperature Tf with the mass % of PS in the block copolymer electrolytes, produced according to the example: not crosslinked, crosslinked (thermal and photochemical activation) and crosslinked/plasticised.
FIG. 3 is a curve that shows the variation in the ionic conductivity (S/cm) according to the ratio 1,000/T in 10³K⁻¹, for SPE according to the invention produced in accordance with the procedure of example 1 and of the control SPE.
FIG. 4 shows curves of Young's modulus in MPa according to the mass % of PS in the block copolymer electrolytes, produced according to example 1: not crosslinked, crosslinked (thermal and photochemical) and crosslinked/plasticised.
FIG. 5 shows a curve that gives the change in the voltage (V) obtained at 40° C. in a symmetric electrochemical cell comprising a SPE according to example 1: plasticised Li/BCP/Li, according to the time in hours subjected to a current density of 0.2 mA/cm².
FIG. 6 shows the curves of the dischargings of a storage battery: Plasticised positive electrode with a base of LiFePO₄ and constituted—in % by weight, of 58% LiFePO₄, 22.25% Polyethylene glycol (PEG), 12% Polyvinylidene fluoride, 5.1% LiTFSI, 2.65%, Carbon Black with a grammage of 0.89 mAh/cm² coated on a collector made of carbon treated aluminium/BCP at 22.1% PS plasticised/Metal lithium negative electrode, voltage in Volts according to the discharged capacity Q/mA·h obtained at 40° C. at different rates (from C/10 to C/0.6) where C in mAh represents the nominal capacity and C/n a discharge current that corresponds to the obtaining of the capacity C in n hours for the storage battery of the example 3.
FIG. 7 shows curves of the discharge capacity in mAh/g of active materials and of coulombic effectiveness in %, according to the number of cycles (the discharge rates are explained on the curve), of the battery of example 3.
FIG. 8 shows a comparison of the performance in power which is the discharge capacity normalised by the nominal capacity (C/Co) according to the discharge rate (C/n), of the copolymer electrolytes at 40° C. implemented in the battery of example 3, with those obtained by the technology of the state of the art constituted of a composite electrode with a homo-PEO base and of an electrolyte with a homo-PEO base in a matrix of rigid polymer such as PVdF at 80° C.
FIG. 9 shows curves of the discharge capacity in mAh/g and of coulombic effectiveness in % according to the discharge rate (C/n), of the storage battery of example 4.
FIG. 10 shows curves of the discharge capacity in mAh/g and of coulombic effectiveness in % according to the discharge rate, of the storage battery of example 5.
FIG. 11 shows a comparison of the performance in power which is the discharge capacity normalised by the nominal capacity (C/Co) according to the discharge rate (C/n), of the copolymer electrolytes at 40° C. implemented in the storage battery of example 5, with those obtained by the technology of the state of the art at 80° C.
FIG. 12A is an exploded view in perspective of a button battery used in example 3 to test the SPE according to the invention.
FIG. 12B is a front detailed view of the storage battery include in the button battery of FIG. 12A.
FIGS. 13A, 13 B & 13C are front views of the lithium metal polymer storage battery used in example 5.

### Example 1: Production of Films of SPE Electrolyte Copolymer 1.1 with PS-PEO_{modified}-PS Blocks Loaded with a Lithium Salt LiTFSI 1.2, Crosslinked and Plasticised with Plasticiser 1.3 TEGDME (Tetraethylene-Glycol-Dimethyl-Ether)

This SPE electrolyte copolymer with PS-PEO_{modified}-PS blocks is loaded with electrolyte lithium salt 1.2 LiTFSI (Bis(trifluoromethane)lithium sulfonimide) with a ratio [M_{B}/M₁₂] or EO/Li=25. It is crosslinked then plasticised with a low quantity of plasticiser 1.2 TEGDME (Tetraethylene-glycol dimethyl ether) (22.9±1.2% by weight TEGDME for 77.1% by weight of (polymer+LiTFSI salt) (Total EO/Li=25).

This SPE is nanostructured with PEO_{modified} domains that supply the ionic conductivity and PS domains a mechanical reinforcement. The nano-structuring is an important aspect for the blocking of the lithium dendrites. The modification of the PEO allows for the crosslinking thereof thus freezing the nanostructure. It further allows the polymer to absorb the plasticiser without substantial loss of mechanical resistance.

This SPE has very good ionic conductivity at 40° C. with 4.6±0.5×10 S/cm, good mechanical resistance (favourable for blocking dendrites). It makes it possible to manufacture composite electrodes with a base of PEO and LiFePO₄, plasticised or not, with high grammages (0.89 and 1.49 mAh/cm²). These electrodes implemented in LMP storage batteries assembled in a button battery. The performance of these storage batteries at 40° C. is greater than or equal (according to the positive electrode) to that of the storage batteries available in the market of which the operating is 80° C., which is a gain of more than 40° C. at equal or greater performance. These results are particularly remarkable for “all-solid-state” systems. The interest with this SPE technology according to invention, is the fundamental gain in safety with respect to lithium-ion batteries using liquid electrolytes at high saturation vapour pressure and highly flammable. Moreover, in comparison with the existing plasticised polymer electrolytes the quality of the plasticiser is here very low (i.e. 22.9±1.2% TEGDME) by weight while still having a conductivity greater than or equal to the state of the art.

### Synthesis of Copolymers and Obtaining of Electrolytes

The PEO is modified by the introduction of an iso-butene function by polycondensation, distributed homogeneously, all along the PEO chain.

The PEGx blocks are obtained by polycondensation between the oligomers of PEO, polyethylene glycol (PEG) and 3-chloro-2-(chloromethyl)-1-propene. They are noted as PEGx with x the molar mass, in kg·mol⁻¹, of the PEG used. The propene/PEG ratio is set to 0.94 with the purpose of obtaining modified PEO with the hydroxyl ends. This synthesis is carried out with PEG of 1.5 kg·mol-1 (PEG_{1.5}) and of 2 kg·mol⁻¹ (PEG₂) leading to polymers having double bonds (isobutene) that can be crosslinked distributed in a controlled manner all along the chain (every 34 or 45 EO units respectively).

### Example of the Synthesis of the Three-Block Copolymer SEGₓS_75

The modified PEO, PEG_{1.5} (Mₙ=18 kg mol⁻¹, 9 g) is dissolved in 250 mL of tetrahydrofurane in a three-neck flask provided with a coolant, a temperature probe and a septum. The solution is stirred under mechanical stirring and heated to 40° C. using an oil bath preheated to 40° C. When the polymer is completely soluble, 7 mL of triethylamine are added to the polymer solution. The mixture is degassed by argon bubbling for 20 min. Under an argon atmosphere, 4.1 mL of acryloyl chloride are added drop-by-drop to the polymer mixture. When the addition is complete, the reaction mixture is allowed to react under an argon atmosphere, under stirring and at 40° C. for 15 h. The solution is then filtered to eliminate the insoluble salts. The filtrate is reconcentrated by rotative evaporation then precipitated in cold ether. The PEG_{1.5}-diacrylate in the form of a white solid is recovered after filtration and vacuum drying.

The maroalkoxyamine PEG_{1.5}-(MAMA-SG1)₂ is obtained by intermolecular radical addition between PEG_{1.5}-diacrylate and the alkoxyamine MAMA-SG1 (BlocBuilder MA, Arkéma). A solution containing PEG_{1.5}-diacrylate (7 g), MAMA-SG1 (1.48 g) and 50 mL of ethanol is introduced into a three-neck flask provided with a coolant and a septum. The solution is degassed by argon bubbling for 30 min then heated under reflux using a heating plate and an oil bath for 4 h. The polymer is then precipitated in cold ether. The PEG_{1.5}-(MAMA-SG1)₂ in the form of a white solid is recovered after filtration and vacuum drying at ambient temperature.

The three-block copolymer SEG_{1.5}S_75 is prepared as follows: 1.2 g of PEG_{1.5}-(MAMA-SG1)₂ as well as 0.7 g of styrene and 2 g of ethylbenzene are introduced into a three-neck flask provided with a coolant, a temperature probe and a septum. The mixture is degassed by argon bubbling for 20 min. The polymerisation is then carried out under argon atmosphere at 120° C. for 5 h. The copolymer is purified by precipitation in cold ether. After drying, the three-block copolymer SEG_{1.5}S_75 is a white solid.

Different compositions PS/PEGx are produced by following the same protocol and by modifying the PEG_{1.5}-(MAMA-SG1)₂/styrene ratio.

Finally, the PS-PEGₓ-PS 1.1 materials obtained are doped with LiTFSI 1.2 salt with also 2% by weight in thermal initiator (benzoyl peroxide) by dissolution in a dichloromethane/acetonitrile solution, with the quantity of salt adapted to produce after pouring the solution and evaporation of the solvent, designated equivalently production solvent, a film with EO/Li of 25 (number of moles of monomer ethylene oxide over the number of moles of 1.2 LiTFSI salt). The plastic films are then crosslinked at 100° C. for 2 hours in order to obtain films from 15 to 200 μm (SPE “XT”). They are then plasticised with the plasticiser 1.3 TEGDME 1M LiTFSI (equivalent in concentration to EO/Li=25) to obtain from 0 to 40% by weight of plasticiser in the membrane.

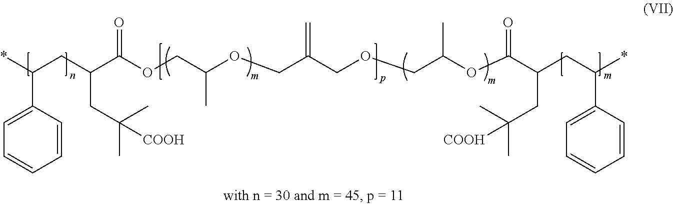

SPE noted as “XUV” are also produced under UV activation by proceeding as follows:

The copolymers PS-PEGₓ-PS 1.1 are doped with 1.2 LiTFSI salt with also 3% by weight of UV photoinitiator (benzoyl peroxide) by dissolution in a dichloromethane/acetonitrile solution, with the quantity of salt adapted to produce after pouring the solution and evaporation of the solvent, designated equivalently production solvent, a film with EO/Li of 25 (number of moles of monomer ethylene oxide over the number of moles of 1.2 LiTFSI salt).

The films are then crosslinked under a UV mercury lamp sold under the commercial name P300 MT Power supply by Fusion UV system Inc. for 30 seconds at 15 mW/cm² under ambient atmosphere. After having been dried and placed in a glove box, the crosslinked films are then plasticised with the plasticiser 1.3 TEGDME 1M LiTFSI (equivalent in concentration to EO/Li=25) in order to obtain from 15 to 40% by weight of plasticiser in the membrane.

In what follows and in the figures reference is made to the following key:

Initial SPE: SPE before crosslinking.
“XT” SPE: Non-plasticised crosslinked SPE under thermal activation obtained as described in example 1.
“XUV” SPE: “XT” SPE: Non-plasticised crosslinked SPE under UV activation obtained as described in example 1.

### Example 2: Characterisation of the SPE Films of Example 1

### 2.1: Nano Structuring

One of the main advantages of these materials is the presence of a nanostructuring of the various domains (PS and PEGx), which makes it possible to have a synergy of the two antagonistic properties, ionic conductivity (PEGx) and mechanical resistance (PS). The crosslinking makes it possible to freeze the nanostructure and to further rigidify the material so as to plasticise it without substantial loss of mechanical resistance.

The mesostructural analysis carried out by X-ray diffusion at the small angles according to the wave vector q in nm⁻¹ (SAXS) [by using a copper cathode (λ=1.54 Å)], confirms that the electrolytes have a nano-separation of the PS phases and crosslinked PEGx, by the presence of a diffraction peak [at q₁≈0.175±0.01 nm⁻¹ (accompanying FIG. 1) for the electrolyte plasticised at 22.9+/−1.2% of TEGDME for 77.1% by weight of (polymer+LiTFSI salt) (total EO/Li=25)—noted as “XT+22.9+/−1.2% TEGDME” in FIG. 1]. This shows that the crosslinking makes it possible to maintain the phase nano-separation. The value of q₁ provides information on the periodicity of the domains D=2π/q₁. For the crosslinked and gelled SPE according to the invention of example 1, a few tens of nanometres are obtained

[D=2π/q₁=2π/(0.175±0.01 nm⁻¹)≈35.9±2.1 nm].

“XT” is the non-plasticised crosslinked SPE under thermal activation obtained as described in example 1.

### 2.2: Glass Transition Temperature Tg/Melting Temperature Tf

To achieve good conductivity at low temperature for SPE, it is necessary to have a low Tg, Tf for the conductive phase, here PEO. The analyse of the thermodynamic properties by DSC (DSC3 Mettler-Toledo, at 10° C./min between −100° C. and 130° C.), shows a sharp drop in the values of Tg, Tf of the PEO phase by the adding of the plasticiser. FIGS. 2A & 2B which respectively relate to Tg and Tf of films obtained in accordance with example 1 having different % by weight of B block in the A-B-A copolymer 1.1.

The SPE according to invention indeed obey Fox's Law:

$$\frac{1}{Tg} = \frac{α}{TgTEG} + \frac{1 - α}{T g P E G}$$

where α is the mass proportion of plasticiser (TEGDME), 1−a the mass proportion of PEO phase, TgTEGDME and TgPEO the transition temperatures of the plasticiser TEGDME and of the PEO phase, respectively.

### 2.3: Conductivity

Conductivity is calculated by the following formula:

$$σ = \frac{l}{S * {R}_{el}}$$

where S and l are respectively the surface and the thickness of the electrolyte. Rₑₗ is the resistance of the electrolyte determined at high frequency by impedance spectroscopy on a symmetrical cell Li/SPE/Li. The temperature is set by means of a climatic enclosure between 10 and 80° C.

The curve of accompanying FIG. 3 shows the variation in the ionic conductivity (S/cm) according to the ratio 1,000/T in 10³K⁻¹, for SPE according to the invention produced in accordance with the procedure of example 1 and of control SPE: polymer PS-PEGx-PS (22.1 wt % PS)+LiTFSI (EO/Li=25); non-crosslinked, crosslinked and crosslinked/plasticised electrolytes at 13.3±0.7 or 22.9±1.2% by weight of TEGDME.

The copolymers without plasticiser 1.3 TEGDME have a conductivity of 8·10⁻⁵S/cm at 40° C., which is too low for use in a battery, in particular at a high rate and high grammage of the positive electrode (>0.8 mAh/cm²). The plasticising by a low quantity of TEGDME makes it possible to achieve a conductivity of magnitude greater than 4.6±0.5*10⁻⁴5/cm, without compromising the mechanical stability of the SPE material.

### 2.4: Mechanical Resistance

Young's modulus is deduced from curves of tensile stress vs elongation obtained thanks to a dynamic mechanical analyser DMA Q800, marketed by the company TA Instruments, and this at 40° C., under dry air sweeping.

As shown in FIG. 4, the crosslinking of the PEGx central block has a substantial impact on the Young's modulus of the electrolytes: an increase by a factor of 10 to 20 is obtained (from 0.15 MPa to 3.3 MPa for PS-PEGx-PS [at 22.1% by weight PS)+LiTFSI (EO/Li=25)]. Adding plasticiser decreases as expected the mechanical properties however a very good conductivity/mechanical resistance compromise is obtained at 40° C. for the materials plasticised according to the invention.

### 2.5: Dendritic Growth of the Lithium

To study the dendritic growth of the lithium of the electrochemical cells comprising a SPE according to invention: Li/SPE/Li, were assembled into a button battery. A characteristic constant current density of 180 μA/cm² is used to displace all the lithium from one electrode to the other. Considering the thickness of lithium and the current density, a duration of 56 h was theoretically expected. FIG. 5 shows that it was necessary to wait 56 h before the divergence in the potential indicating that the cell was not short-circuited before all the lithium was displaced.

### Example 3: Tests of the SPE According to the Invention with Lithium Metal Polymer Storage Battery

A button battery is manufactured as indicated hereinafter

Electrolyte thickness: 26 μm
Plasticised positive electrode with a base of LiFePO₄ and constituted—as % by weight, of 58% LiFePO₄, 22.25% polyethylene glycol (PEG), 12% polyvinylidene fluoride, 5.1% LiTFSI, 2.65%, carbon black with a grammage of 0.89 mAh/cm² coated on a collector made of carbon coated aluminium.
Metal lithium negative electrode

Discs of composite cathode, of SPE and of lithium are cut out respectively to the diameters, 8, 12 and 10 mm. The lithium and SPE discs are laminated at 80° C. to ensure good Li/SPE contacts, then finally the composite cathode is laminated over the Li/SPE unit. The Li/SPE/Cathode sandwich is assembled between two stainless steel shims A spring is placed on the upper stainless steel shim and the whole is crimped in a button battery. The internal pressure on the electrochemical cell is about 1.5 bar.

This button battery is referenced as —1— in the diagrams of FIGS. 12A & 12B. It comprises: a cup —2—, a circular electrochemical storage battery —3— sandwiched between a 1^{st} lower stainless steel shim —4— (1^{st} disc) and a 2^{nd} upper stainless steel shim —4— (2^{nd} disc). A spring —5— is disposed between this 2^{nd} shim/disc —4— and a cover —6—. As it appears more particularly in FIG. 12B, the electrochemical storage battery —3— is constituted by a multilayer Li—33—/SPE—32—/composite cathode —31— coated on the surface of a collector made of carbon coated aluminium. This multilayer rests on the 1^{st} lower stainless steel shim —4—.

For these tests with a LMP storage battery, the electrolyte PS-PEGx-PS was tested at 22.1%_{modified}-PS crosslinked and plasticised at 22.9±1.2% TEGDME with a content in 1.2 LiTFSI of EO/Li=25.

The discharge curves (i. e. discharged capacity in mAh/g) obtained at 40° C. at different rates (from C/10 to C/0.6) where C in mAh/g of active materials represents the total theoretical capacity and C/n a discharge current that corresponds to the obtaining of the capacity C in n hours, are shown in FIG. 6. Up to C/4, the restored capacity is rather constant and starts to fall starting at C/2 due to limitations by the transport of material.

The “cyclability” at 40° C. obtained at different discharge rates (the charge always being at a low rate C/10 or C/15) is shown in FIG. 7. Very good resistance in “cycling” over 50 cycles associated with a faradaic efficiency of 99.5% (at C/10), are obtained.

Finally, performance at 40° C. in power is shown in FIG. 8: which is the discharge capacity normalised by the nominal capacity (C/Co) according to the discharge rate (C/n), of the copolymer electrolytes at 40° C. implemented in the battery of example 3, with those obtained by the technology of the state of the art constituted of composite electrode based on homo-PEO and an electrolyte based on homo-PEO in a rigid polymer matrix such as PVdF at 80° C.

The results clearly show that the SPE according to invention are superior to the commercial electrolytes, in terms of restored capacity in particular at a high rate >C/2 and this despite a lower temperature 40° C.

### Example 4: Tests of the SPE According to the Invention with Lithium Metal Polymer (LMP) Storage Battery

This example relates to a copolymer electrolyte containing 30% by weight of PS, but still plasticised at 22.9±1.2% by weight of (1.2) TEGDME. In addition to the slightly different content in PS, the main difference is the thickness of the film of electrolyte which here is 100 micrometres, which is nearly 4 times thicker than in the preceding example. For the rest, the assembly, the negative and positive electrodes are identical.

FIG. 9 shows the cyclability obtained at 40° C. over 50 cycles. Note in particular the very good stability (reversibility) of the restored capacity (80% of the nominal capacity) for relatively fast rates, with a charge at C/5 and a discharge at C/3. Again, the faradaic efficiency is very close to 1 (99.2% at C/8) and shows the very good reversibility of these systems. These results therefore confirm the interest of SPE according to the invention for the LMP technology at 40° C.

### Example 5: Tests of the SPE According to Invention with Lithium Metal Polymer (LMP) Storage Battery

FIGS. 13A, 13 B & 13C show the lithium metal polymer storage battery used in this example. The films SPE —9— of example 1 of a thickness of 37 μm, are laminated at low pressure at ambient temperature between a sheet of lithium —10— and the composite cathode —11— coated over a carbon-treated portion —12t— of the current collector made of aluminium —12—. The active surface —13— is defined by the surface of the material of the cathode.

A copper conducting wire —14c— is connected to the lithium —10— and an aluminium conducting wire —14a— is connected to the cathode —11— via the current collector —12—. This sandwich structure is then vacuum heat sealed in an aluminised polyethylene bag 15, from which the collector wires exit in order to conduct the electrochemical tests.

The cathode is comprised of 74% by mass of LiFePO₄, 0.5% by mass of carbon black Ketjenblack (EC600-jd, AkzoNobel), 20.1% by mass of co-P(EO)-(OB) (ICPSEB, 115,000 g/mol, Nippon shokubai) and 5.4% by mass of LiTFSI. The grammage is 1.49 mAh/cm².

The storage battery is manufactured from a cathode standard provided to operate at 80° C. The cathode will be partially plasticised by the TEGDME contained in the plasticised electrolyte. This means that a portion of the TEGDME of the SPE diffuses inside the cathode and plasticises the binder with a PEO base of this cathode until the balance is reached between the quantity of TEGDME in the electrolyte of the cathode, on the one hand, and in the SPE, on the other hand.

The electrolyte selected is the same as the one of example 1. The thickness is however greater (37 μm vs 26 μm for the cell with a plasticised cathode) so as to limit the impact of the loss of plasticiser on the conductivity of the electrolyte.

FIG. 10 shows the “cyclability” curve over 57 cycles obtained at 40° C. and at different discharge rates. The initial drop in the capacity associated with an efficiency of 95%, is due to the gelling of the cathode and therefore the balancing of the plasticiser between the electrolyte and the cathode. However, after 10 cycles reversibility is excellent and the efficiency tends towards 1 (value 0.997 at C/10).

FIG. 11 shows the performance in power:
obtained at 40° C. for storage batteries (SPE at 22.1% PS plasticised at 22.9±1.2% TEGDME) with plasticised and non-plasticised cathodes,
and compared to the industrial reference already used in the preceding examples obtained at 80° C.

The results obtained are remarkable, in light of the thickness of the electrolyte (37 μm), of the very grammage of the electrode of 1.49 mAh/cm², for an electrode not optimised to operate at 40° C., but at 80° C.

1. A Solid Polymer Electrolyte (SPE) comprising:
at least one linear three-block A-B-A or two-block A-B copolymer wherein:
the A block or blocks are glassy or semi-crystalline polymers;
the B block is a polymer
that can be produced from a plurality of alkylene-glycol (AG) monomers selected from ethylene oxide (EO) and/or propylene oxide (PO);
and/or selected from poly(ethylene-glycol) acrylates (PEGA), and/or poly(ethylene-glycol) methacrylates (PEGMA), and/or polyoxypropylene diamines;
optionally one or more silicone polymer, oligomer or monomer segments being distributed between the A and B blocks;
at least one electrolyte salt;
and at least one plasticiser, selected from polar solvents of molar mass less than or equal to 1000 g/mol, the concentration in plasticiser being comprised between 15% excluded and 40% included in dry weight with respect to the total mass of the SPE.

2. The SPE according to claim 1 wherein the SPE is at least partially cross-linked.

3. The SPE according to claim 1, wherein the A block polymers and/or the B block polymer, is/are carriers of at least two crosslinking groups CG per molecule, said groups CG being able to react together to form crosslinking bridges.

4. The SPE according to claim 1, wherein the A blocks are polymers produced from at least one monomer, selected from:
styrene and the mono- or poly-substituted derivatives thereof;
anisole and the mono- or poly-substituted derivatives thereof;
aniline and the mono- or poly-substituted derivatives thereof;
benzoic acid and the mono- or poly-substituted derivatives thereof;
naphthalene and the mono- or poly-substituted derivatives thereof;
anthracene and the mono- or poly-substituted derivatives thereof;
pyridine and the mono- or poly-substituted derivatives thereof;
an acrylamide and the mono- or poly-substituted derivatives thereof;
acrylic acid, methacrylic acid, the salts thereof and the mono- or poly-substituted derivatives thereof.

5. The SPE according to claim 1, wherein the plasticiser is selected from the group comprising:
ethers;
carbonates;
nitriles;
lactones;
and the mixtures thereof.

6. The SPE according to claim 1, wherein the SPE comprises:
at least one thermal initiator;
and/or at least one photochemical initiator.

7. The SPE according to claim 1, presenting a nano-separation between at least one phase comprising the A blocks and at least one phase comprising the B block, the volume fraction of the A block being comprised between 15% and 40%.

8. The SPE according to claim 1, presenting a nano-separation between at least one phase comprising the A block or blocks and at least one phase comprising the B block, the period of the nano-separation being substantially comprised between 20.5 nm and 41 nm.

9. The SPE according to claim 1, wherein the B block and the plasticiser form a homogeneous mixture.

10. The SPE according to claim 1, wherein the SPE has an ionic conductivity at 40° C. greater than or equal to 1.10⁻⁴ S/cm and a Young's modulus (in MPa, at 40° C., and for a mass % of B block comprised between 10 and 40% in the three-block A-B-A 1.1) greater than or equal to 0.05.

11. A method for producing a SPE according to claim 1, wherein the method comprises:
Implementing or synthesizing the three-block A-B-A copolymer 1.1;
doping the products obtained in step (i) by mixing them with at least one electrolyte salt in solution;
incorporating the plasticiser.

12. An electrochemical storage battery comprising an electrolyte and electrodes, wherein at least one SPE according to claim 1, is present in the electrolyte and/or in at least one of the electrodes.

13. An electrode for electrochemical device wherein the electrode comprises at least one SPE according to claim 1.

14. The SPE according to claim 4, wherein, when the at least one monomer, from which the A blocks polymers are produced, is selected from:
styrene and the mono- or poly-substituted derivatives thereof, the at least one monomer is selected in the group comprising: o-methylstyrene, p-methylstyrene, m-t-butoxystyrene, 2,4-dimethylstyrene, m-chlorostyrene, p-chlorostyrene, 4-carboxystyrene, 4-chloromethylstyrene and the combinations thereof;
anisole and the mono- or poly-substituted derivatives thereof, the at least one monomer is selected in the group comprising: 4-vinylanisole, 3-vinylanisole, 2-vinylanisole;
aniline and the mono- or poly-substituted derivatives thereof, the at least one monomer is selected in the group comprising: 4-vinylaniline, 3-vinylaniline;
benzoic acid and the mono- or poly-substituted derivatives thereof, the at least one monomer is selected in the group comprising: 4-vinylbenzoic acid, 3-vinylbenzoic acid, 2-vinylbenzoic acid, 4-(2-propenyl)benzoic acid;
naphthalene and the mono- or poly-substituted derivatives thereof, the at least one monomer is selected in the group comprising: 2-vinylnaphthalene, 1-vinylnaphthalene;
anthracene and the mono- or poly-substituted derivatives thereof, the at least one monomer is selected in the group comprising: 9-vinylanthracene;
pyridine and the mono- or poly-substituted derivatives thereof, the at least one monomer is selected in the group comprising: 4-vinylpyridine, 2-vinylpyridine;
an acrylamide and the mono- or poly-substituted derivatives thereof, the at least one monomer is selected in the group comprising: acrylamide, N,N-dimethyl acrylamide, N,N-diisopropyl acrylamide, N-hydroxyethyl acrylamide;
acrylic acid, methacrylic acid, the salts thereof and the mono- or poly-substituted derivatives thereof, the at least one monomer is selected in the group comprising:
alkyl acrylates from 1 to 10C, alkyl methacrylates from 1 to 10C, acrylic acid.

15. The SPE according to claim 5, wherein the plasticiser is chosen from the group comprising alkylene-glycols, linear carbonates and cyclic carbonates; succinonitrile; γ-butyrolactone.

16. The SPE according to claim 6, wherein:
the at least one thermal initiator is selected from the group comprising peroxides, hydroperoxides, nitriles and the mixtures thereof;
and/or the at least one photochemical initiator is selected from phenyl ketones and the mixtures thereof.

17. The method according to claim 11, wherein implementing or synthesizing the three-block A-B-A copolymer is performed:
by polycondensation, on the one hand, of B sub-blocks of molar mass comprised between 0.5 and 5 kg·mol⁻¹, and, on the other hand, of at least one precursor of unsaturated segments;
then by radical polymerisation with the recurring units of the A blocks.

18. The method according to claim 11, wherein the method comprises adding at least one initiator selected among a photoinitiator and a thermal initiator.

19. The method according to claim 11, wherein the method comprises eliminating at least partially the solvent or solvents present in the mixture.

20. The method according to claim 11, wherein the method comprises crosslinking, by thermal activation, at a temperature greater than or equal to 60° C.; and/or by actinic activation.
